(19) United States
(12) Patent Application Publication
(10) Pub. No.: US 2008/0053495 A1
(43) Pub. Date: Mar. 6, 2008

(54) FLUID CLEANING SYSTEM

(75) Inventors: James D. Franks, Menominee, MI (US); Robert James Stenfors, Bark River, MI (US); Gabe Robert Kluka, Escanaba, MI (US); Jeremy Scott Carlson, Gladstone, MI (US)

Correspondence Address: BROOKS KUSHMAN P.C., 1000 TOWN CENTER, TWENTY-SECOND FLOOR, SOUTHFIELD, MI, 48075, US

(73) Assignee: EMP ADVANCED DEVELOPMENT, LLC, Escanaba, MI (US)

(21) Appl. No.: 11/470,429

(22) Filed: Sep. 6, 2006

(51) Int. Cl. B08B 3/00; B08B 3/12

(52) U.S. Cl. 134/58 R; 134/56 R; 134/184; 134/198

(57) ABSTRACT

A fluid cleaning system includes a fluid source connected to a pump that is used to increase the pressure of the fluid. A two-way valve selectively allows the higher pressure fluid to flow back into the tank, or to flow to a rotary union. The union has a nozzle attached to it to provide a fluid stream to contact an object, such as a workpiece, to be cleaned of dirt, debris, or surface irregularities. The union is attached to a robot arm, and contains locating features which allow the fluid stream to be accurately located relative to the workpiece. This allows the entire system to be automated, thereby providing advantages such as speed and efficiency.

### BACKGROUND OF THE INVENTION

1. Field of the Invention

The present invention relates to a fluid cleaning system, and in particular, a system that produces a stream of water for cleaning a workpiece.

2. Background Art

In manufacturing settings, it is often desirable to clean a workpiece that may be covered with dirt and oil, or metal chips or other debris, resulting from the manufacturing processes. Moreover, unfinished workpieces, such as metal castings, may have rough surfaces or burrs that need to be removed. There are various processes, well known to those in manufacturing, for cleaning and deburring parts. For example, it may be possible to clean some parts by placing them in a bath of mineral spirits to remove dirt and oil, and even metal shavings or other debris. Smoothing the surfaces of, and removing burrs from, a rough workpiece, such as a metal casting, can be achieved with a grinding tool applied to the workpiece at the necessary locations.

Conventional processes such as these, in addition to being time consuming and labor intensive, may not be appropriate for large, bulky workpieces that are difficult to maneuver. Moreover, using separate operations to clean foreign matter, and remove burrs, from the surfaces of a workpiece may be inefficient. Therefore, a need exists for a system capable of cleaning and deburring a workpiece in the same operation. Moreover, a need exists for such a system to be automated, thereby increasing the efficiency and the consistency of the process.

### SUMMARY OF THE INVENTION

Accordingly, the present invention provides a fluid cleaning system that can be used to clean dirt, oil, or other foreign matter from the surface of an object. Embodiments of cleaning systems in accordance with the present invention are also capable of deburring and otherwise smoothing the surfaces of an object such as a rough casting. Because the operation of removing burrs from the surface of an object can be considered a type of “cleaning,” the present invention will be hereinafter referred to in terms of a “cleaning” system, though it is understood that embodiments of the present invention can be used for cleaning, deburring, or other applications where a positionable fluid stream is required.

Embodiments of the present invention provide a fluid cleaning system, and in some embodiments, a high pressure water cleaning system, that can be used to clean and deburr an object, such as a manufacturing workpiece. The system includes an articulating apparatus, such as a robot arm, that is operable to position a fluid stream from a nozzle to contact the object to be cleaned. A fluid source, such as a tank, provides a supply of fluid to feed the fluid stream that is applied to the workpiece. The fluid may be, for example, water, or a solution of water and a cleaning fluid. A pump is provided for increasing the pressure of the water to an appropriate magnitude to accomplish the desired type of cleaning. It is understood that the pump may be adjustable, or different pumps may be used, to accommodate different cleaning applications. In some applications, the pressure of the fluid output by the pump may be, for example, in the neighborhood of 5000 pounds per square inch (psi) or higher.

The output from the pump is connected to a two-way valve that can selectively provide the high pressure water to a union and nozzle assembly for generating the water stream, or alternatively, to provide water back into the water tank. This provides a mechanism for temporarily stopping water flow to the nozzle without having to cycle the pump on and off. When it is desired to temporarily stop the flow of water to the nozzle, the valve can be actuated to close the appropriate outlet, and open another outlet to feed the water back to the water tank.

When it is desired to generate the water stream to act on the workpiece, the valve can be operated to open the appropriate outlet, while closing the outlet connected to the water tank. Water from the valve is fed into a rotary union having a nozzle attached thereto. The union is attached to the robot arm so the nozzle can be appropriately positioned. The robot can be preprogrammed with a control sequence, or it can be operated using real time commands, preferably from a remote location.

Embodiments of the present invention include a two-way shuttle valve, having a valve body including a valve inlet for receiving a fluid, such as water, and two valve outlets for outputting the fluid from the valve. The valve body may be made from tool steel, stainless steel, or other high strength materials when high pressure applications are contemplated. The valve body also includes two valve seats, each of which is disposed proximate a respective one of the valve outlets. The valve further includes a first channel forming a portion of a fluid path between the valve inlet and the first valve outlet. A second channel in the valve forms a portion of a fluid path between the valve inlet and the second valve outlet.

A piston is disposed within the valve body, and includes first and second piston heads. The piston is movable between a first position and a second position. In the first position, the first piston head cooperates with the first valve seat to close the fluid path between the valve inlet and the first valve outlet. In the second position, the second piston head cooperates with the second valve seat to close the fluid path between the valve inlet and the second valve outlet. Embodiments of the present invention include shuttle valves that are configured such that as the piston moves between the first and second positions, both valve outlets are at least partially open at the same time. This can help mitigate the effects of the pressure change as one outlet opens and the other closes.

Each of the piston heads has a respective first surface disposed proximate the valve inlet such that fluid entering the valve inlet exerts a force against each of the first surfaces. The first piston head includes an elongate portion configured to cooperate with the first channel such that fluid in the first channel provides a reaction force to the force of the fluid on the first surface of the first piston head as the piston moves into the first position. The second piston head includes an elongate portion configured to cooperate with the second channel such that fluid in the second channel provides a reaction force to the force of the fluid on the first surface of the second piston head as the piston moves into the second position. In this way, movement of the piston is dampered despite the high pressure of the inlet fluid against the first surfaces of the piston heads. Without this mechanism, the fluid entering the valve would have a tendency to slam the piston head into the valve seat as the valve was being moved into the first or second position.

To effect movement of the piston in the valve, embodiments of the valve also include an actuator mounted on the valve body. The actuator may be, for example, a linear actuator of a pneumatic, hydraulic, or electromechanical type. The use of the externally mounted actuator provides an advantage over internal actuators, in that linkages can be attached on either side of the actuator to provide a mechanical advantage for moving the piston in the valve body. In this way, the size of the actuator can be kept at a minimum, while still providing the necessary force to act against the high pressure fluid moving through the valve.

As discussed above, fluid can exit the valve through an outlet that is connected to a rotary union having a nozzle attached thereto. Embodiments of the union include a first portion having a fluid inlet and a second portion at least partly disposed within the first portion and having a fluid outlet. The second portion is configured to rotate relative to the first portion. The union further includes a mounting structure configured for attachment to the articulating apparatus and having a first locating feature configured to cooperate with a feature on the articulating apparatus to radially locate the second portion relative to the articulating apparatus. The union also has a coaxial locating feature configured to axially locate the second portion relative to the articulating apparatus.

In one embodiment, the mounting structure of the union includes a mounting face having a plurality of apertures configured to receive fasteners for attaching a robot arm thereto. In such embodiments, the first locating feature of the union can include another aperture configured to receive a pin attached to the robot arm. Thus, the mounting face of the union can be bolted to the robot arm and located relative to the robot arm with a locating pin. This provides a known radial orientation between the rotating portion of the union and the robot arm, which, as described below, will ultimately allow the robot to accurately position the fluid stream exiting the nozzle. In such an embodiment, the coaxial locating feature can include a boss raised above a primary surface of the mounting face.

The union also includes a second locating feature that is disposed proximate the fluid outlet at a predetermined radial orientation relative to the first locating feature. This provides a known radial orientation between the robot arm, or other articulating apparatus, and the second locating feature. The nozzle is configured for attachment at the fluid outlet of the union to receive fluid therefrom. The nozzle includes a nozzle outlet through which the stream of fluid will exit. Of course, nozzles in accordance with embodiments of the present invention, may include a plurality of nozzle outlets, each of which is disposed at a predetermined location for accurately positioning the nozzle relative to the object, such as the workpiece.

Embodiments of the present invention include a nozzle having a plurality of nozzle outlets symmetrically arranged around the circumference of the nozzle. This helps balance the forces on the nozzle caused by the high pressure fluid exiting the nozzle outlets. In this way, bending moments on the nozzle can be reduced. The nozzle may have more than one set of nozzle outlets along the length of the nozzle. Such a configuration can provide multiple fluid streams to simultaneously contact different portions of a workpiece along its length. Embodiments of the present invention may also include an axial hole instead of, or in addition to, the circumferential hole or holes. Such a configuration may be particularly useful for cleaning chips and other debris from blind holes. In case the nozzle outlet or outlets becomes clogged with debris, a relief valve can be provided as an alternative path for the fluid to exit, thereby avoiding a pressure build up in the system.

The nozzle also includes a locating feature that is disposed at a predetermined radial orientation relative to the nozzle outlet or outlets. The locating feature of the nozzle is configured to cooperate with the second locating feature of the union. Because, as described above, the second locating feature of the union is positioned at a known radial orientation relative to the articulating apparatus, such as the robot arm, the locating feature on the nozzle provides a known radial orientation between the articulating apparatus and the nozzle outlet or outlets. This facilitates use of an automated system that can provide accurate positioning of the fluid stream on an object, such as a workpiece. The use of an automated system, such as those contemplated by the present invention, not only increases the efficiency of the cleaning process, but also allows relatively large objects to be cleaned without providing a hazardous environment to the cleaning technician.

### BRIEF DESCRIPTION OF THE DRAWINGS

FIG. 1 is a schematic representation of a high pressure fluid cleaning system in accordance with one embodiment of the present invention;

FIG. 2 is a perspective view of a two-way shuttle valve illustrated schematically in FIG. 1;

FIG. 3 is a top sectional view of the shuttle valve shown in FIG. 2;

FIG. 4 is a detailed sectional view of a portion of the valve shown in FIG. 3;

FIG. 5 is a perspective view of a rotary union illustrated schematically in FIG. 1; and

FIG. 6 is a sectional view of the rotary union illustrated in FIG. 5, having a nozzle attached thereto.

### DETAILED DESCRIPTION OF THE PREFERRED EMBODIMENTS

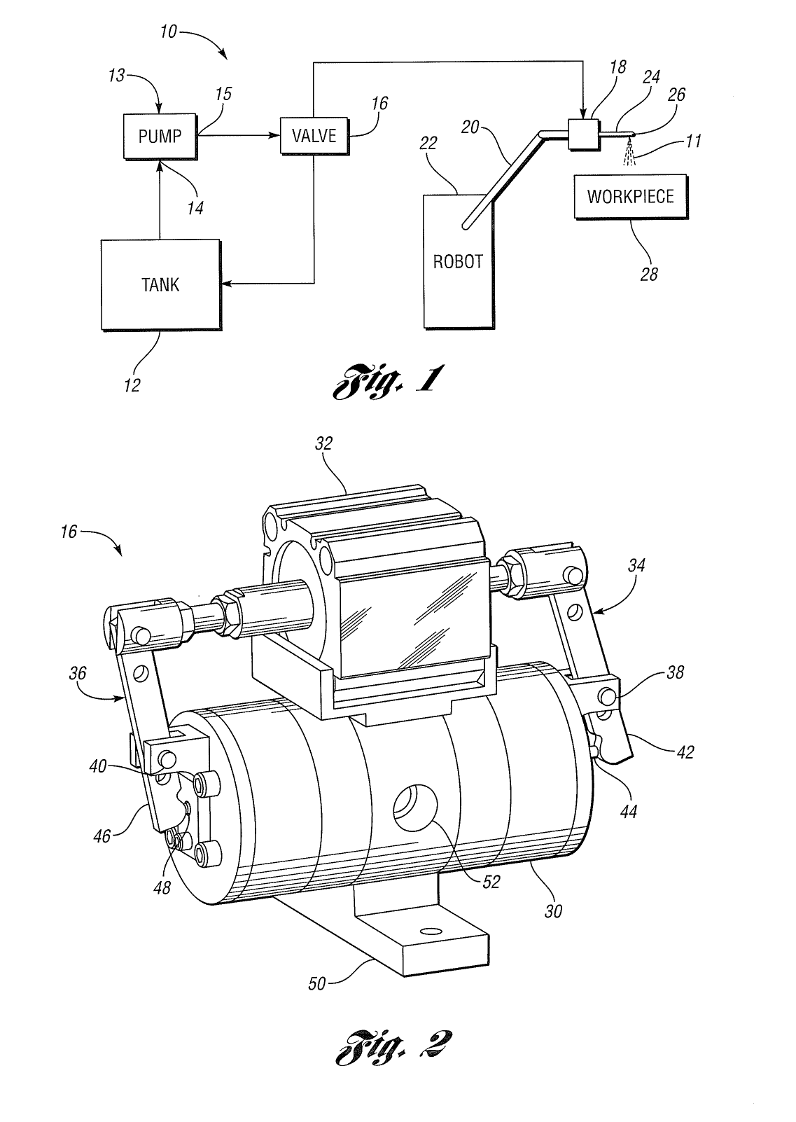

FIG. 1 shows a fluid cleaning system in accordance with one embodiment of the present invention. As discussed above, cleaning systems in accordance with the present invention, for example the cleaning system 10, can be used to clean dirt and debris from objects, and in some embodiments, may be used to clean burrs or other surface irregularities from an object, such as a manufacturing workpiece. The system 10 is configured to provide a high pressure fluid stream 11, which, in the embodiment shown in FIG. 1, is water. It is understood, however, that other types of fluids, water and non-water based, can be used with the present invention. The fluid source for the system 10 is a water tank 12, shown in FIG. 1. The tank 12 provides water to a pump 13, which has an inlet 14 for receiving water from the tank 12, and an outlet 15 to provide water at an increased pressure to a valve 16.

The valve 16 is a two-way shuttle valve that can be operated to selectively provide water to a rotating union 18, or alternatively, back to the tank 12. By providing a mechanism for the water to be transferred back to the tank 12, water flow to the union 18 can be stopped without turning off the pump 13, and without creating undesirably high stresses in the system 10, which may occur if the pump 13 is operating and the flow of water is stopped.

The union 18 is attached to an articulating apparatus, which in the embodiment shown in FIG. 1, is a robot arm 20. The robot arm 20 is part of a programmable robot 22, of the type frequently used in industrial and other manufacturing settings. Attached to the union 18 is a nozzle 24 that receives the water through the union 18, and outputs the water through a nozzle outlet 26. As shown in FIG. 6 and described below, the nozzle 24 includes two nozzle outlets, 26, 26′, though for illustrative purposes, the schematic drawing of FIG. 1 shows only the outlet 26. The high pressure stream of water 11 exits the nozzle 24 through the nozzle outlet 26, and contacts an object to be cleaned, such as workpiece 28. Although FIG. 1 shows a single stream of water 11 exiting the nozzle 24, it is understood that a nozzle, such as the nozzle 24, may have multiple nozzle outlets, thereby generating multiple fluid streams. As discussed above, such nozzle outlets can include one or more nozzle outlets radially oriented around the circumference of a nozzle, including one or more nozzle outlets at different locations along the length of a nozzle. In addition, or as an alternative, a nozzle can include an axially oriented outlet.

FIG. 2 shows a perspective view of the valve 16, which is illustrated schematically in FIG. 1. The valve 16 includes a valve body 30 and an actuator 32 mounted externally to the valve body 30. In the embodiment shown in FIG. 2, the actuator 32 is a pneumatic linear actuator, although other types of actuators may be used in accordance with the present invention. For example, hydraulic, mechanical, or electromechanical actuators, such as solenoids, can be used. By externally mounting the actuator 32 on the valve body 30, an advantage is gained through the use of linkages 34, 36. Having actuators that are mounted internally to a valve requires a large valve body, and may also limit or preclude the use of mechanical advantage devices, such as the linkages 34, 36. The linkages 34, 36 pivot about pivot points 38, 40, and therefore, act as a lever to increase the force output by the actuator 32. This allows the actuator 32 to be kept to a relatively small size, while still providing an adequate force to actuate the internal mechanisms of the valve 16.

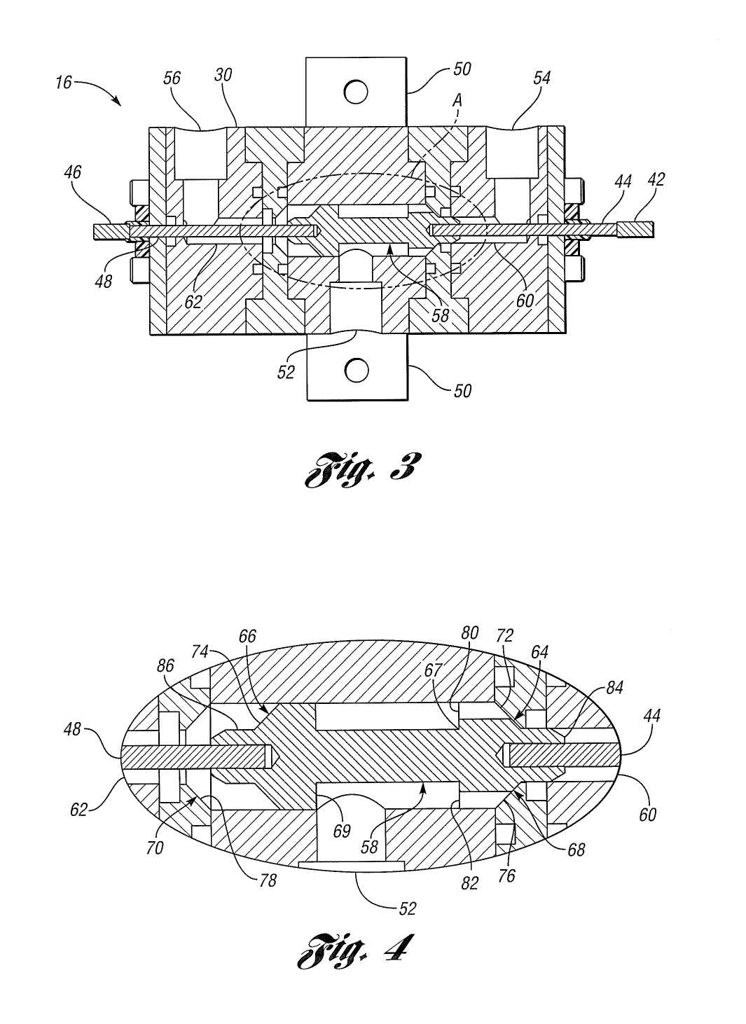

One end 42 of the linkage 34 acts on a connecting rod 44, while one end 46 of the linkage 36 acts on a connecting rod 48. As described in more detail below, the connecting rods 44, 48 facilitate movement of a piston within the valve body 30. The valve 16 also includes a mounting bracket 50, and a valve inlet 52, which is configured to communicate with a pump, such as the pump 13 shown in FIG. 1. In addition to the inlet 52, the valve 16 includes two valve outlets 54, 56, shown in FIG. 3. FIG. 3 is a top sectional view of the valve 16. As shown in FIG. 3, the connecting rods 44, 48 are connected to a piston 58 disposed within the valve body 30. The valve body 30 includes two channels 60, 62, which respectively provide a portion of a fluid path between the inlet 52 and the outlets 54, 56. Details of the piston 58 are shown in FIG. 4, which provides a closeup view of Detail A indicated in FIG. 3.

As shown in FIG. 4, the piston 58 includes two piston heads 64, 66. Each of the piston heads 64, 66 includes a respective first surface 67, 69 that is disposed proximate the valve inlet 52, such that fluid entering the valve inlet 52 exerts a force against the first surfaces 67, 69. As described below, one of the advantages of the valve 16 is that it is configured to reduce or eliminate impact on the piston heads 64, 66 that would otherwise result from the high forces generated by the inlet fluid.

Each of the piston heads 64, 66 is configured to cooperate with a respective valve seat 68, 70. In particular, a tapered portion 72, 74 of the piston heads 64, 66 is configured to mate with corresponding tapered portions 76, 78 of the valve seats 68, 70. In order to provide a path for fluid to flow from the inlet 52 to either of the outlets 54, 56—see FIG. 3—fluid passages are provided through the piston heads 64, 66. For example, as shown in FIG. 4, fluid passages 80, 82 traverse the piston head 64. In a first position as shown in FIG. 4, no fluid flows from the inlet 52 into the channel 60, because the piston head 64 is securely mated with the valve seat 68. It is understood that fluid passages also exist in the piston head 66, but are oriented at approximately 90 degrees from the passages 80, 82, and are therefore not visible in FIG. 4. It is through such passages, however, that fluid will flow from the inlet 52 through the piston head 66, and into the channel 62.

As described above, the valve 16 is configured to reduce the impact seen by the piston 58, and in particular, seen by the piston heads 64, 66, that would otherwise result from the high forces generated by the high pressure fluid entering the inlet 52. As shown in FIG. 4, the piston head 64 includes an elongate portion, or nose 84, that is configured to cooperate with the channel 60. Specifically, the outside diameter of the nose 84 is only slightly smaller than the inside diameter of the channel 60. Similarly, the piston head 66 includes an elongate portion, or nose 86, which is configured to cooperate with the channel 62. Starting with the piston 58 in the first position shown in FIG. 4, the actuator 32—see FIG. 2—can be operated to move the piston 58 to the left into a second position to open the channel 60, and close the channel 62. In the second position, the piston head 66 securely mates with the valve seat 70.

As the actuator 32 begins to move the piston and fluid begins to flow into the channel 60, the high pressure fluid entering the inlet 52 will have a tendency to act on the surface 69 of the piston head 66, thereby forcing it to the left. The effect of this force is mitigated, however, as the nose 86 begins to enter the channel 62, thereby constricting the amount of fluid that can flow back through the piston head 66 from the channel 62. The fluid in the channel 62 must be pushed forward, and this provides a reaction force to dampen movement of the piston 58 toward the valve seat 70. This configuration reduces or eliminates the impact seen by the piston heads 64, 66, thereby increasing the longevity of the valve 16.

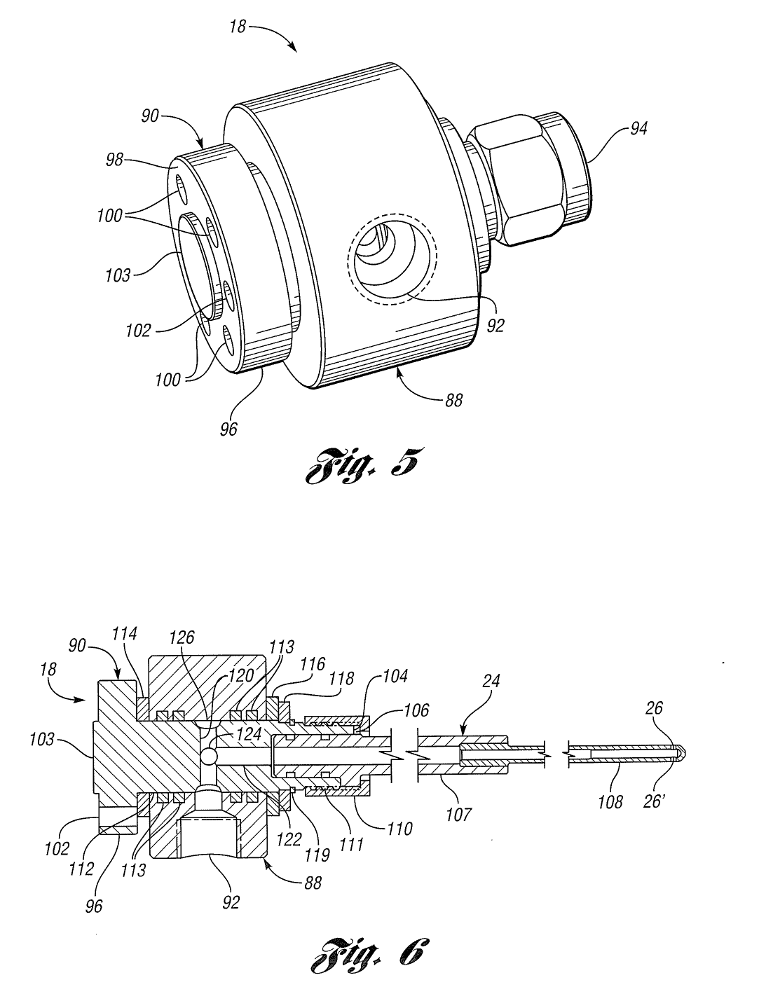

FIG. 5 shows an isometric view of the rotary union 18, which is illustrated schematically in FIG. 1. The union 18 includes a first portion 88, and a second portion 90 that is configured to rotate within the first portion 88. The union 18 includes a fluid inlet 92 that is configured to receive fluid from the valve 16 through one of the valve outlets 54, 56. The union 18 also includes a fluid outlet 94, which, as described below, is configured to receive a nozzle, such as the nozzle 24 shown in FIG. 1. The second portion 90 of the union 18 includes a mounting structure 96 which, in the embodiment shown in FIG. 5, has a mounting face 98 configured with a plurality of threaded holes 100 to facilitate attachment of the union 18 to an articulating apparatus, such as the robot arm 20 shown in FIG. 1.

In addition to the threaded holes 100, the mounting face 98 includes a first locating feature, which in the embodiment shown in FIG. 5, is an aperture 102. The aperture 102 is configured to receive a pin or other fastener that will align the mounting face 98 with a portion of the robot arm 20 so that there is a known radial orientation between the position of the robot arm 20 and the second portion 90 of the union 18. The mounting face 98 also includes a coaxial locating feature, which, in the embodiment shown in FIG. 5, is a circular boss 103. Of course, other types of coaxial locating features may be used, for example, locating pins. The boss 103 is configured to cooperate with a recess in the robot arm 20 so that there is known axial orientation in two orthogonal directions between the position of the robot arm 20 and the union 18. The boss 103 effectively centers the second portion 90 of the union 18 on the robot arm 20.

In addition to the first locating feature 102, and the boss 103, the union 18 also includes a second locating feature 104, shown in FIG. 6. FIG. 6 is a sectional view of the union 18 having the nozzle 24 attached thereto. Although illustrated schematically in FIG. 1 with a single nozzle outlet 26, the detailed view of FIG. 6 shows that the nozzle 24 includes two nozzle outlets 26, 26′. The second locating feature 104 is positioned at a predetermined radial orientation relative to the first locating feature 102, thereby providing a known radial orientation between the robot arm 20 and the second locating feature 104. As described below, this facilitates proper positioning of the nozzle 24 relative to the workpiece 28—see FIG. 1.

As shown in FIG. 6, the second locating feature 104 forms an elongate member that is configured to cooperate with a locating feature, or recessed portion 106, in the nozzle 24. The recessed portion 106 is disposed at a predetermined radial location relative to the nozzle outlets 26, 26′. Therefore, the robot 22 can be programmed to accurately position the nozzle outlets 26, 26′ so that the fluid stream 11 contacts the workpiece 28 at the desired location—see FIG. 1. In summary, the robot 22 is programmed to know the position of the robot arm 20. The robot arm 20 is attached to the union 18 with a known radial orientation because of the first locating feature 102. The nozzle 24 can be attached in only one position to the union 18—i.e., the nozzle 24 is keyed to the union 18—because of the cooperation between the recessed portion 106 and the second locating feature 104. Finally, the nozzle outlets 26, 26′ have a known radial orientation to the recessed portion 106, which provides known positioning from the nozzle outlets 26, 26′ back through the union 18 to the robot arm 20 so that the robot 22 can appropriately position the nozzle 24.

In the embodiment shown in FIG. 6, the nozzle 24 is made up of two members 107, 108, each of which has been shortened in the drawing figure for illustrative purposes. The nozzle 24 is held in place by a retaining nut 110 that cooperates with threads 111 on the second portion 90 of the union 18. As shown in FIG. 6, the second portion 90 includes a generally cylindrical portion 112 that is disposed within the first portion 88. O-ring seals 113 are used to keep fluid from leaking out of the union 18. In addition, because the second portion 90 rotates within the first portion 88, friction washers 114, 116 are disposed between the two portions 88, 90. A retainer 118 is held in place with a snap ring 119, and keeps the two portions 88, 90 together.

To facilitate fluid flow through the union 18, the second portion 90 has a number of apertures disposed therethrough. For example, a transverse aperture 120 is disposed through the second portion 90, and connects with an axial aperture 122 to provide an outlet path for the fluid. In order to ensure that the union 18 can accommodate a desired amount of fluid flow, a second transverse aperture, such as the aperture 124, may be provided. In addition, the second portion 90 of the union 18 includes an annular groove 126 that communicates with the transverse apertures 120, 124. This helps to ensure uninterrupted fluid flow as the second portion 90 rotates into positions where neither of the transverse apertures 120, 124 are directly aligned with the fluid inlet 92. Of course, other embodiments may use more or less than two of the transverse apertures to achieve the desired fluid flow. In some embodiments, the second port 90 may rotate at approximately 80 revolutions per minute (rpm), and the groove 126 helps to ensure adequate fluid flow regardless of the speed or position of the second portion 90 relative to the first portion 88.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A cleaning system including an articulating apparatus for positioning a fluid stream to contact a structure to be cleaned, the system comprising:
a union including a first portion having a fluid inlet and a second portion at least partly disposed within the first portion and having a fluid outlet, the second portion being configured to rotate relative to the first portion, the union further including a mounting structure configured for attachment to the articulating apparatus and having a first locating feature configured to cooperate with a feature on the articulating apparatus to radially locate the second portion relative to the articulating apparatus, the union further including a second locating feature disposed proximate the fluid outlet at a predetermined radial orientation relative to the first locating feature, thereby providing a known radial orientation between the articulating apparatus and the second locating feature; and
a nozzle configured for attachment to the fluid outlet of the union to receive fluid therefrom, the nozzle including a nozzle outlet and a locating feature disposed at a predetermined radial orientation relative to the nozzle outlet, the nozzle outlet being configured to provide a fluid stream therefrom, the locating feature of the nozzle being configured to cooperate with the second locating feature of the union, thereby providing a known radial orientation between the articulating apparatus and the nozzle outlet.

2. The cleaning system of claim 1, the articulating apparatus including a robot arm, and wherein the mounting structure of the second portion of the union includes a mounting face configured to receive a plurality of fasteners for attaching the robot arm thereto.

3. The cleaning system of claim 2, wherein the union further includes a coaxial locating feature configured to cooperate with a feature on the articulating apparatus to axially locate the second portion relative to the articulating apparatus.

4. The cleaning system of claim 2, wherein the first locating feature of the union includes an aperture configured to receive a pin attached to the robot arm.

5. The cleaning system of claim 4, wherein the second locating feature of the union includes an elongate member, and the locating feature of the nozzle includes a recessed portion configured to receive the elongate member.

6. The cleaning system of claim 5, wherein the second portion of the union includes a generally cylindrical portion having an annular groove disposed therein, the annular groove being aligned with the fluid inlet of the first section such that fluid entering the fluid inlet enters the annular groove, the generally cylindrical portion including a transverse aperture and an axial aperture communicating with the transverse aperture and the fluid outlet, the transverse aperture communicating with the annular groove such that fluid entering the fluid inlet traverses the transverse and axial apertures and exits the union through the fluid outlet.

7. The cleaning system of claim 6, wherein the generally cylindrical portion includes two of the transverse apertures disposed generally perpendicularly to each other, thereby providing an increase in the volumetric flow rate of fluid achievable through the union.

8. A cleaning system including a fluid source, a pump for increasing the pressure of fluid received from the fluid source, and an articulating apparatus having a nozzle attached thereto for positioning a fluid stream from the nozzle to contact a structure to be cleaned, the system comprising:
a valve configured to be positioned downstream from the pump for selectively providing fluid to the nozzle and fluid to the fluid source, the valve including:
a valve body including a valve inlet for receiving fluid, two valve outlets for outputting fluid from the valve, and two valve seats, each of the valve seats being disposed proximate one of the valve outlets,
a first channel forming a portion of a fluid path between the valve inlet and the first valve outlet,
a second channel forming a portion of a fluid path between the valve inlet and the second valve outlet, and
a piston disposed within the valve body and including first and second piston heads, the piston being movable between a first position where the first piston head cooperates with the first valve seat to close the fluid path between the valve inlet and the first valve outlet, and a second position where the second piston head cooperates with the second valve seat to close the fluid path between the valve inlet and the second valve outlet,
each of the piston heads having a respective first surface disposed proximate the valve inlet such that fluid entering the valve inlet exerts a force against each of the first surfaces, the first piston head including an elongate portion configured to cooperate with the first channel such that fluid in the first channel provides a reaction force to the force of the fluid on the first surface of the first piston head as the piston moves into the first position, the second piston head including an elongate portion configured to cooperate with the second channel such that fluid in the second channel provides a reaction force to the force of the fluid on the first surface of the second piston head as the piston moves into the second position.

9. The cleaning system of claim 8, wherein the valve further includes an actuator mounted thereon for moving the piston between the first and second positions.

10. The cleaning system of claim 9, wherein the actuator includes a linear actuator having a pair of linkages attached thereto for providing a mechanical advantage for moving the piston between the first and second positions.

11. The cleaning system of claim 10, wherein the linear actuator includes one of a pneumatic actuator, a hydraulic actuator, or a solenoid.

12. The cleaning system of claim 8, wherein each of the valve seats of the valve includes a tapered portion and each of the piston heads includes a tapered portion configured to mate with one of the tapered portions on a respective valve seat, each of the elongate portions of the piston heads extending outwardly from a tapered portion on a respective one of the piston heads.

13. The cleaning system of claim 12, wherein each of the pistons includes a respective fluid passage therethrough, configured such that fluid will flow through the passage when the respective piston is not mated with a respective one of the valve seats and fluid will not flow through the passage when the respective piston is mated with a respective one of the valve seats.

14. A cleaning system including an articulating apparatus for positioning a fluid stream from a nozzle to contact a structure to be cleaned, the system comprising:
a fluid source;
a pump including a pump inlet and a pump outlet, the pump inlet communicating with the fluid source to receive fluid therefrom, the pump being configured to increase the pressure of the fluid received and to pump the fluid through the pump outlet;
a valve including a valve inlet and two valve outlets, the valve inlet communicating with the pump outlet to receive fluid therefrom, a first of the valve outlets communicating with the fluid source to provide fluid back to the fluid source; and
a union including a fluid inlet communicating with the second valve outlet to receive fluid therefrom and a fluid outlet for outputting fluid to the nozzle, the union further including a first portion and a second portion at least a part of which is rotatably disposed within the first portion, the union further including a mounting structure configured for attachment to the articulating apparatus and having a first locating feature configured to cooperate with a feature on the articulating apparatus to locate the second portion relative to the articulating apparatus, the union further including a second locating feature disposed proximate the fluid outlet at a predetermined radial orientation relative to the first locating feature, thereby providing a known radial orientation between the articulating apparatus and the second locating feature.

15. The cleaning system of claim 14, further comprising the nozzle attached to the fluid outlet of the union to receive fluid therefrom, the nozzle including a nozzle outlet and a locating feature disposed at a predetermined radial orientation relative to the nozzle outlet, the nozzle outlet being configured to provide a fluid stream therefrom, the locating feature of the nozzle being configured to cooperate with the second locating feature of the union, thereby providing a known radial orientation between the articulating apparatus and the nozzle outlet.

16. The cleaning system of claim 15, the articulating apparatus including a robot arm, and wherein the mounting structure of the second portion of the union includes a mounting face configured to receive a plurality of fasteners for attaching the robot arm thereto.

17. The cleaning system of claim 15, wherein the second locating feature of the union includes an elongate member, and the locating feature of the nozzle includes a recessed portion configured to receive the elongate member.

18. The cleaning system of claim 15, wherein the valve further includes:
a first channel forming a portion of a fluid path between the valve inlet and the first valve outlet,
a second channel forming a portion of a fluid path between the valve inlet and the second valve outlet, and
a piston including first and second piston heads, the piston being movable between a first position where the first piston head cooperates with the first valve seat to close the fluid path between the valve inlet and the first valve outlet, and a second position where the second piston head cooperates with the second valve seat to close the fluid path between the valve inlet and the second valve outlet,
each of the piston heads having a respective first surface disposed proximate the valve inlet such that fluid entering the valve inlet exerts a force against each of the first surfaces, the first piston head including an elongate portion configured to cooperate with the first channel such that fluid in the first channel provides a reaction force to the force of the fluid on the first surface of the first piston head as the piston moves into the first position, the second piston head including an elongate portion configured to cooperate with the second channel such that fluid in the second channel provides a reaction force to the force of the fluid on the first surface of the second piston head as the piston moves into the second position.

19. The cleaning system of claim 18, wherein each of the valve seats of the valve includes a tapered portion and each of the piston heads includes a tapered portion configured to mate with one of the tapered portions on a respective valve seat, each of the elongate portions of the piston heads extending outwardly from a tapered portion on a respective one of the piston heads.

20. The cleaning system of claim 18, wherein the valve further includes an actuator mounted thereon for moving the piston between the first and second positions.

21. The cleaning system of claim 20, wherein the actuator includes a linear actuator having a pair of linkages attached thereto for providing a mechanical advantage for moving the piston between the first and second positions.
